(19) United States
(12) Patent Application Publication
(10) Pub. No.: US 2026/0135362 A1
(43) Pub. Date: May 14, 2026

(54) MULTIFUNCTIONAL WATERPROOF JUNCTION BOX WITH WIRES ENTERING FROM FOUR SURFACES

(71) Applicant: Capatronics Electronics (Kunshan) Co.,Ltd., Suzhou (CN)

(72) Inventors: Chuanbao Wang, Shou (CN); Zhiwei Wang, Kunshan (CN)

(21) Appl. No.: 19/443,257

(22) Filed: Jan. 8, 2026

(30) Foreign Application Priority Data
Oct. 21, 2025 (CN) 202511504061.6

(51) Int. Cl. H02G 3/08

(52) U.S. Cl. CPC H02G 3/088; H02G 3/083

(57) ABSTRACT

The disclosure discloses a multifunctional waterproof junction box with wires entering from four surfaces, including a main box body and a detachably connected cover body. A connector portion that may be mounted in the waterproof junction box of the disclosure is at least one of a data connector or an electric socket, so more diversified use requirements and mounting environments can be satisfied. A side of the main box body away from the cover body is a mounting surface, the main box body is rotated around a central axis by 90 degrees each time so as to correspond to four mounting positions sequentially, the cover body has the same mounting state at each position, a fixing region of the main box body is also the same, and a user may arbitrarily adjust a mounting direction of the main box body to meet different direction setting requirements of a terminal.

### TECHNICAL FIELD

The present disclosure relates to a multifunctional waterproof junction box with wires entering from four surfaces.

### BACKGROUND

During the mounting of incoming wires or cables, junction boxes are frequently required to accommodate a connector portion which achieves an adaption function. However, the use performance of existing junction boxes remains unsatisfactory, with issues such as significant limitations in use direction and single functions. For instance, a turning-over portion, separated from a main box body, of a cover body needs to be arranged near a lower side of a junction box to enable a user to open the cover body conveniently. Correspondingly, the main box body also needs to be arranged in the same direction. In practical mounting, however, the mounting requirement of a terminal portion on the main box body is not limited in a single direction, so that users cannot arbitrarily adjust the mounting direction of the main box body. Moreover, wiring requirements for junction boxes are becoming increasingly diverse. At present, there is no waterproof junction box that can comprehensively meet users' varied needs.

### SUMMARY

In order to solve the above technical problems, the present disclosure provides a multifunctional waterproof junction box with wires entering from four surfaces. The multifunctional waterproof junction box is used for accommodating a connector portion, and the connector portion is at least one of a data connector or an electric socket. The multifunctional waterproof junction box includes a main box body and a cover body detachably connected to the main box body, a terminal is arranged on at least one side wall of the main box body, and the cover body is provided with a lead interface used for a lead connected to the connector portion to penetrate out. The cover body includes: a connecting cover, wherein the connecting cover is connected to the main box body, and an opening for exposing a connector region of the connector portion is formed in the middle of the connecting cover; and an outer cover, wherein the outer cover is in hinged connection with the connecting cover and is able to be mutually closed with the connecting cover. A side of the main box body away from the cover body is a mounting surface, any position for fixing the main box body through the mounting surface is a first mounting position, the main box body is rotated around a central axis thereof and is rotated by an angle of 90 degrees each time so as to correspond to a second mounting position, a third mounting position and a fourth mounting position of the main box body sequentially, and when the main box body is located at the first mounting position, the second mounting position, the third mounting position and the fourth mounting position respectively, the cover body is in the same mounting state, and a region where the main box body is fixed is always the same region.

The present disclosure has the following beneficial effects.

(1) The types of connector portions that may be accommodated by the waterproof junction box of the present disclosure include the data connector (e.g., a network module, an optical fiber splice, an HDMI connector, a USB connector, a TYPE-C connector, etc.) and the electric socket, and at least one type of connector portion may be arranged in the same box body, so that the more diversified use requirements and mounting environments can be satisfied, thereby achieving the effect of one box with multiple functions.

(2) By using the waterproof junction box of the present disclosure, the mounting direction of the main box body can be adjusted arbitrarily to achieve the effect of arranging the terminal in different directions, but the cover body can be always maintained in the same mounting state or the same mounting direction, so that a user can conveniently open the cover body and expose the connector portion, thus facilitating operations. Meanwhile, when the main box body is located at the different mounting positions respectively, the junction box can also be located in the same region all the time, so that the user can mount the junction box more conveniently, and the user just needs to arrange the same group of mounting structures (e.g., mounting holes, etc.) in a region where the junction box is to be fixed.

(3) The main box body of the junction box of the present disclosure may be adjusted at the four mounting positions as required, however, no matter which mounting position the junction box is located, the cover body can always match with the main box body, so that, through the function of the multiple mounting positions of the main box body of the present disclosure, it is ensured that the cover body can be in the ideal mounting direction. Therefore, the junction box has stable waterproof performance and can meet the requirement for multiple mounting directions of the user.

Further, a first waterproof edge extending towards the outer cover is arranged on at least part of a region on the connecting cover surrounding the opening, a second waterproof edge extending towards the connecting cover is arranged on the outer cover, and when the outer cover is closed onto the connecting cover, side walls of the first waterproof edge and the second waterproof edge are attached to each other. Therefore, liquid (e.g., water) can be effectively prevented from entering the junction box through the opening to affect the connector portion, and liquid seeping via the cover body can be effectively isolated to a water collecting area.

Furthermore, the multifunctional waterproof junction box further includes an interface sealing portion, the interface sealing portion is arranged at a region of the lead interface, the lead is able to penetrate through the interface sealing portion, a drainage gap is located between the interface sealing portion and a wall portion of a region of the cover body where the lead interface is arranged, and a side of the lead interface close to the main box body has a lead draining groove recessed towards the main box body. Therefore, by arranging the interface sealing portion, it can be ensured that water cannot seep into the junction box from the region of the lead interface when the lead is guided out, and the lead draining groove is arranged to discharge few liquids located in the drainage gap.

Furthermore, the first waterproof edge and the second waterproof edge are interrupted at a region of the interface sealing portion to form a mounting opening, an accommodating groove for arranging the interface sealing portion is arranged at a region on the connecting cover corresponding to the mounting opening, and a groove wall of one side of the accommodating groove close to the opening extends away from the main box body. Therefore, the interface sealing portion can form a waterproof structure together with the first waterproof edge and the second waterproof edge so as to effectively prevent liquid from entering the main box body. The groove wall of the side of the accommodating groove close to the opening extends away from the main box body, so that seeping liquid can be blocked by the groove wall and cannot enter the waterproof box. A tail end of the first waterproof edge close to the interface sealing portion has a bent area extending away from the opening, the bent area extends towards the interface sealing portion, and the accommodating groove has a water blocking wall extending away from the main box body. Therefore, the liquid in the water collecting area can be isolated effectively, is prevented from entering the region of the accommodating groove, and is discharged from a drain hole with a high drainage volume.

Furthermore, a sealing groove is further arranged around an outside of the first waterproof edge, a first sealing ring is arranged in the sealing groove, and the first sealing ring is able to abut against the water blocking wall. Therefore, the water collecting area and the region where the lead interface is arranged are isolated to the maximum extent to reduce liquid entering the region of the lead interface as much as possible.

Furthermore, a water collecting area is arranged on one side of the connecting cover close to the outer cover, when the outer cover and the connecting cover are mutually closed, the water collecting area and the opening are isolated from each other, and a drain hole capable of communicating with the water collecting area is formed in an edge of one side of the connecting cover. The first sealing ring protrudes from a bottom wall of the water collecting area, and by arranging the cover body as the two structures: the connecting cover and the outer cover, and arranging the water collecting area on the connecting cover, the water collecting area and the opening are isolated from each other when the outer cover and the connecting cover are closed. By adjusting the direction of the connecting cover to enable the drain hole to face downwards, when the waterproof junction box is placed in an environment where the box is susceptible to liquid splashing or wetting, liquid seeping into the waterproof junction box can be discharged via the drain hole. By using the junction box of the present disclosure, it can be ensured that the orientation of the cover body is kept consistent when the main box body is located at the respective different mounting positions, and the drain hole is kept downward, so that the waterproof junction box has high waterproof and dustproof levels, with an IP rating up to IP66.

Furthermore, at least one mounting hole is formed in the mounting surface of the main box body, a waterproof sleeve extending from an inner side wall of the mounting surface of the main box body into the main box body is arranged around the mounting hole, and a waterproof cover for blocking the mounting hole is arranged at one end of the waterproof sleeve located inside the main box body. Therefore, after the main box body is fixed by a bolt penetrating through the mounting hole, the waterproof cover is closed onto one end of the waterproof sleeve, and then liquid can be prevented from entering the waterproof junction box via the mounting hole, effectively performing the waterproof effect. When the waterproof junction box needs to be rotated by an angle to different mounting positions, the waterproof box may be taken down first, and then a disassembling action of the main box body is performed, which meets the use requirement that the junction box needs to be rotated by different mounting angles during practical use.

Furthermore, four mounting holes are provided, and when the main box body is located at the first mounting position, the second mounting position, the third mounting position and the fourth mounting position respectively, the respective mounting holes have the same projection on a surface where mounting is to be performed. Therefore, a user can adjust the mounting angle of the main box body as required. Since before and after rotating the main box body, the respective mounting holes correspond to the same mounting structure (e.g., mounting hole positions, etc.), the main box body can be conveniently mounted and fixed at multiple angles.

Furthermore, the multifunctional waterproof junction box further includes at least one locking portion used for locking the outer cover and the connecting cover, wherein the outer cover is provided with a through hole for the locking portion to pass, the locking portion has a limiting end, an outer diameter of one side of the limiting end close to the outer cover is greater than a diameter of the through hole, the locking portion further includes a waterproof member, the waterproof member includes a waterproof ring, the waterproof ring sleeves the locking portion, and the waterproof ring is able to abut against the limiting end and an outer surface of the connecting cover respectively.

Furthermore, the locking portion includes a locking sleeve and a lock bar arranged inside the locking sleeve and able to rotate relative to the locking sleeve, one end of the lock bar is an unlocking end, the other end is a lock head end, the unlocking end is located at an end of the locking sleeve away from the connecting cover, a cylindrical hole capable of communicating with the locking sleeve is provided in the middle of the limiting end, and the unlocking end is located in the cylindrical hole. The waterproof member further includes a waterproof cap capable of sealing the cylindrical hole and a connecting arm connected to the waterproof ring and the waterproof cap respectively. Therefore, the waterproof member can be mounted in place in one time as long as the locking portion is sleeved with the waterproof ring. When no unlocking or locking action is required, seepage at the locking portion can be prevented just by covering the cylindrical hole with the waterproof cap.

The lock head end is further provided with a lock plate, the connecting cover is provided with a locking hole, a limiting wall capable of shielding part of a region of the locking hole is arranged on one side of the locking hole close to the limiting end, the lock plate is arranged at one end of the locking portion extending into the locking hole, and the lock plate is able to rotate to abut against the limiting wall. Therefore, the locking portion can be fixed to or released from the cover body just by slightly rotating the locking portion to enable the lock plate to abut against the limiting wall or not, so that locking or unlocking of the outer cover and the connecting cover is facilitated. A size of a region not shielded by the limiting wall is a little bit larger than that of the lock plate, so that the lock plate can penetrate into the locking hole conveniently and be rotated to abut against the limiting wall so as to achieve the locking effect.

Furthermore, the multifunctional waterproof junction box further includes a clamping portion for clamping the cover body and the main box body, wherein the clamping portion includes a clamping tongue arranged on the cover body, and when the cover body and the main box body are closed, the clamping tongue is able to be clamped into the drain hole.

### BRIEF DESCRIPTION OF THE DRAWINGS

FIG. 1 is a schematic perspective view of a multifunctional waterproof junction box with wires entering from four surfaces according to one embodiment of the present disclosure.

FIG. 2 is a schematic perspective view of a multifunctional waterproof junction box with wires entering from four surfaces according to another embodiment of the present disclosure.

FIG. 3 is a schematic perspective view of a waterproof junction box with a connector portion inside being an optical fiber splice according to one embodiment of the present disclosure.

FIG. 4(a) is a schematic perspective view of a waterproof junction box with a connector portion inside being two different optical fiber splices according to one embodiment of the present disclosure.

FIG. 4(b) is a schematic perspective view of a waterproof junction box with a connector portion inside being an optical fiber splice and a network module according to one embodiment of the present disclosure.

FIG. 5 is a schematic diagram of a waterproof junction box with a connector portion inside being a USB connector and/or an HDMI connector according to one embodiment of the present disclosure.

FIG. 6 is a schematic perspective view of a waterproof junction box with a connector portion inside being an electric socket according to one embodiment of the present disclosure.

FIG. 7 is a schematic perspective view of a connecting cover according to one embodiment of the present disclosure.

FIG. 8 is a schematic perspective view of an outer cover according to one embodiment of the present disclosure.

FIG. 9 is a schematic structural diagram of a mounting surface of a main box body according to one embodiment of the present disclosure.

FIG. 10 is a schematic structural diagram of a waterproof blocking wall of a connecting cover according to one embodiment of the present disclosure.

FIG. 11 is a schematic structural diagram of a waterproof sleeve in a main box body according to one embodiment of the present disclosure.

FIG. 12 is a schematic diagram of a connection relationship between an interface sealing member I and an interface sealing member II according to one embodiment of the present disclosure.

FIG. 13 is a schematic structural diagram of a locking portion according to one embodiment of the present disclosure.

FIG. 14 is a schematic structural diagram of a waterproof member according to one embodiment of the present disclosure.

FIG. 15 is a schematic structural diagram of a clamping portion of a waterproof junction box according to one embodiment of the present disclosure.

FIG. 16 is a schematic structural diagram of a wire clip according to one embodiment of the present disclosure.

FIG. 17 is a schematic diagram of an implementation of a fixing device for arranging a connector portion in a waterproof junction box of the present disclosure.

### DESCRIPTION OF THE EMBODIMENTS

Hereinafter, preferred embodiments of the present disclosure are described in detail with reference to the accompanying drawings, so that the advantages and features of the present disclosure can be more easily understood by those skilled in the art, thereby defining the scope of protection of the present disclosure more clearly and explicitly.

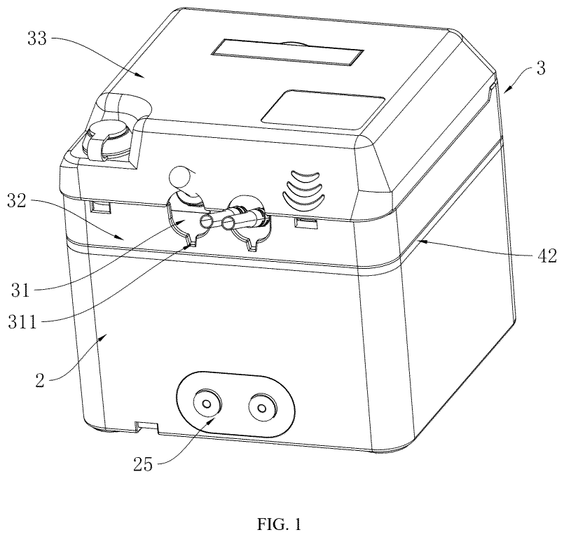

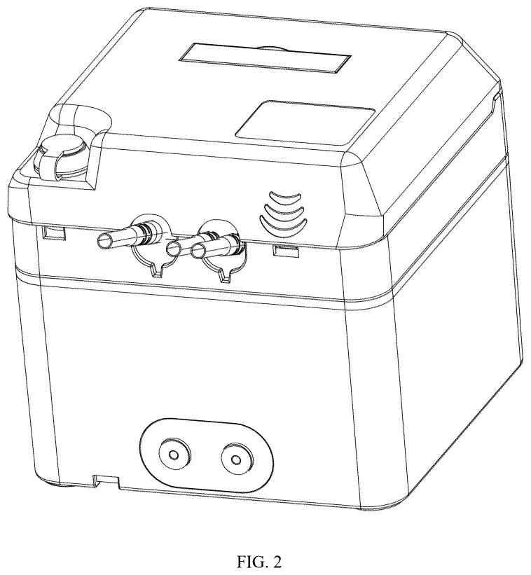

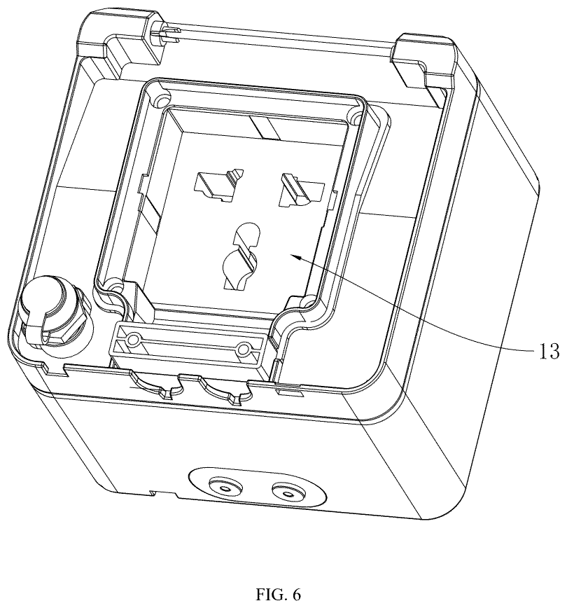

Referring to FIGS. 1-6, this embodiment provides a multifunctional waterproof junction box with wires entering from four surfaces, used for accommodating a connector portion. The multifunctional waterproof junction box includes a main box body 2 and a cover body 3 detachably connected to the main box body 2, a terminal 25 is arranged on at least one side wall of the main box body 2, and the cover body 3 is provided with a lead interface 31 used for a lead connected to the connector portion to penetrate out. The main box body 2 is also in a completely sealed state at the terminal 25, only exposing a connecting interface of the terminal 25 on the surface of the main box body 2.

The connector portion mounted in the same waterproof junction box may be at least one of a data connector or an electric socket. In some embodiments, the connector portion mounted in the same waterproof box may be selected from at least one of a network connector (e.g., a Keystone Coupler, a network module 11, an HDMI connector 15, a USB connector 14, a TYPE-C connector, and an optical fiber splice (connectors such as LC, SC, FC or ST)) or an electric socket 13. For example, the network module 11 and the TYPE-C connector may be arranged on the same fixing device together, and the fixing device is placed into the waterproof box, so that different types of connector portions can be fixed and accommodated.

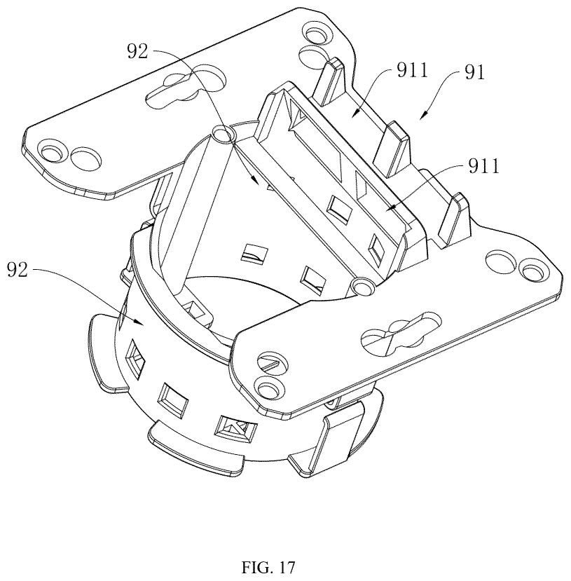

In some implementations, as shown in FIG. 17, the fixing device has a winding portion 92 and a snap-fit portion 91 for fixing the connector portion. Different connector portions can be mounted by fixing different data connectors onto the fixing device so as to meet the multi-scenario use and mounting requirements, and wires or cables inside the box body are still arranged orderly. However, the volume of the waterproof junction box of the present application is still the volume of a conventional junction box, so that the waterproof junction box of the present disclosure has the higher universality. When connector portions desired to be fixed have a large difference in dimension, the shape of a snap-fit groove 911 of the snap-fit portion 91 of the fixing device may be adjusted, and the junction box is correspondingly equipped with a plurality of types of fixing devices. However, the different types of fixing devices have the consistent dimension, so that different fixing devices can be mounted in the junction box, and then the waterproof junction box can accommodate different types of connector portions.

In some implementations, when the connector portion is a connector other than the electric socket, the cover body 3 further includes a limiting cover 35. The limiting cover 35 is located on an inner side of the connecting cover 32 and can abut against the connector portion when the cover body 3 is closed. When the connector portion in the present application is the connector other than the electric socket, respective connector portions are arranged in a manner of inclining from the cover body 3 to one side of the box body from outside to inside, so that plug-in connection is facilitated. However, a space is formed between the connector portion and a bottom side of the cover body 3, and thus the space is filled with the limiting cover 35 to ensure firm mounting of the connector portion. Meanwhile, the limiting cover 35 is arranged detachably, so that when the electric socket needs to be mounted in the box body, the limiting cover 35 can be taken down easily, and thus the waterproof box of the present application further meets the multi-scenario use requirements.

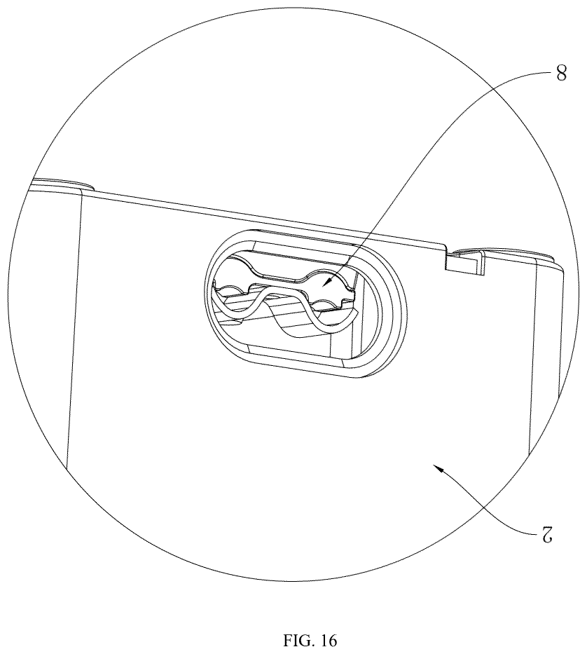

Referring to FIG. 16, in some implementations, a wire clip 8 is further arranged at a position in the main box body 2 corresponding to the terminal 25.

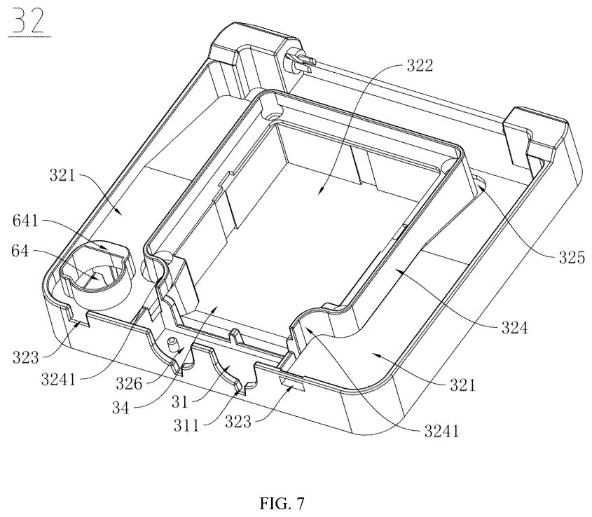

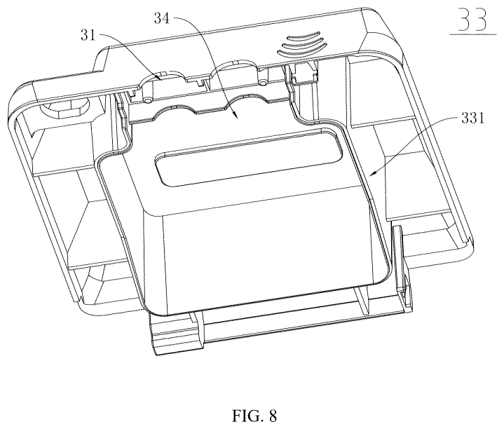

Referring to FIG. 7 and FIG. 8, the cover body 3 includes a connecting cover 32 and an outer cover 33, the connecting cover 32 is detachably connected to the main box body 2, and an opening 322 for exposing a connector region of the connector portion is formed in the middle of the connecting cover 32, so that users' operations are facilitated. The outer cover 33 is in hinged connection with the connecting cover 32 and can be mutually closed with the connecting cover 32. A water collecting area 321 (in conjunction with FIG. 7) is arranged on one side of the connecting cover 32 close to the outer cover 33, and when the outer cover 33 and the connecting cover 32 are mutually closed, the water collecting area 321 and the opening 322 are isolated from each other. A drain hole 323 capable of communicating with the water collecting area 321 is formed in an edge of one side of the connecting cover 32. Therefore, when the waterproof junction box is placed in an environment where the box is susceptible to liquid splashing or wetting, by adjusting the direction of the connecting cover 32 to enable the drain hole 323 to face downwards, liquid seeping into the waterproof junction box can be discharged via the drain hole 323.

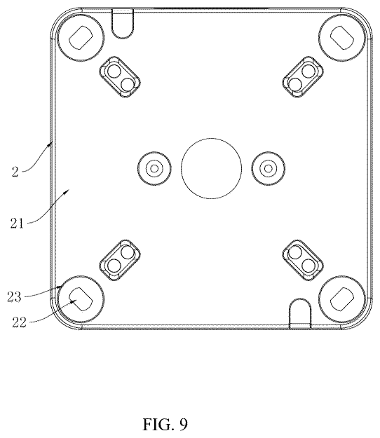

A side of the main box body 2 away from the cover body 3 is a mounting surface 21 (see FIG. 9), any position for fixing the main box body 2 through the mounting surface 21 is a first mounting position, the main box body 2 is rotated around a central axis thereof and is rotated by an angle of 90 degrees each time so as to correspond to a second mounting position, a third mounting position and a fourth mounting position of the main box body 2 sequentially, and when the main box body 2 is located at the first mounting position, the second mounting position, the third mounting position and the fourth mounting position respectively, the cover body 3 is in the same mounting state, and a region where the main box body 2 is fixed is always the same region. Therefore, the mounting direction of the main box body 2 can be adjusted by a user arbitrarily to achieve the effect of arranging the terminal 25 in different directions, but the cover body 3 can be always maintained in the same mounting state or the same mounting direction, so that the user can conveniently open the cover body 3 and expose the connector portion, thus facilitating operations. Meanwhile, when the main box body 2 is located at the different mounting positions respectively, the main box body can also be located in the same region all the time, so that the user can mount the main box body more conveniently, and the user just needs to arrange the same group of mounting structures (e.g., the mounting hole 22, etc.) in a region where the main box body is to be fixed. For example, in case only the lead interface 31 is arranged on the side wall of one side of the main box body 2, the lead interface 31 needs to be arranged in different directions because of different actual mounting environments, and therefore, the waterproof junction box of the present disclosure can meet the diversified mounting requirements.

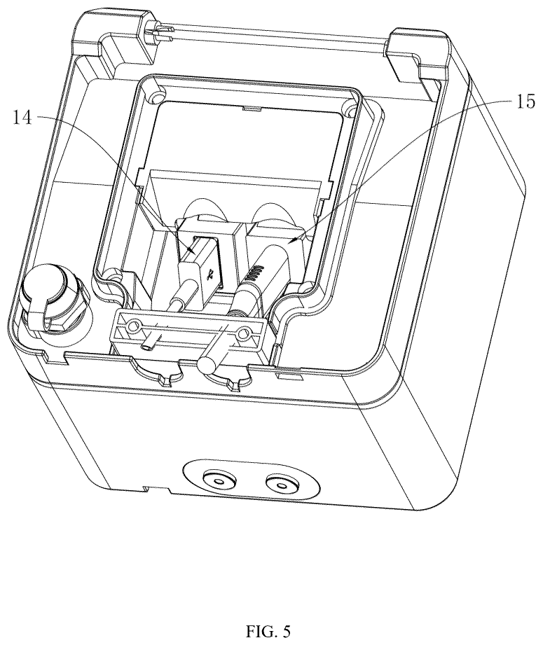

According to the waterproof junction box of the present disclosure, the cover body 3 is arranged as the two structures: the connecting cover 32 and the outer cover 33, the water collecting area 321 is arranged on the connecting cover 32, and the water collecting area 321 and the opening 322 are isolated from each other when the outer cover 33 and the connecting cover 32 are closed, so that the waterproof junction box has high waterproof and dustproof levels, with an IP rating up to IP66. The connector portion of the present disclosure may be at least one of the network module 11, the optical fiber splice 12 or the electric socket 13. For example, when there are two or more connector portions, the connector portions may be the network modules 11 completely or the optical fiber splices 12 completely or the electric sockets 13 completely, and may also simultaneously contain the network module 11 and the optical fiber splice 12 (FIG. 5).

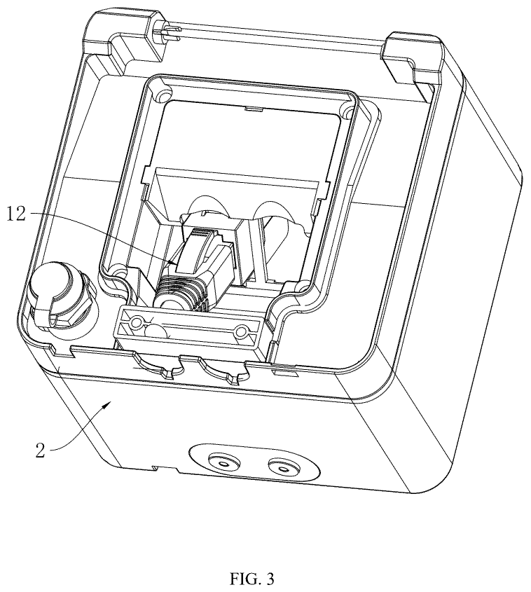

Referring to FIGS. 3-5, when the connector portion is the network module 11 and/or the optical fiber splice 12, in order to disassemble the connector portion conveniently, the connector portion is obliquely arranged in the main box body 2, so that a hollowed-out structure is formed at the lower end of the connector portion. At this time, the cover body 3 further includes the limiting cover 35, and the limiting cover 35 is located on the inner side of the connecting cover 32 and can abut against the connector portion when the cover body 3 is closed. Therefore, the better fixing effect on the connector portion can be achieved by arranging the limiting cover 35. The connector portion of the present disclosure may be fixed in the main box body 2 through the fixing device. In some implementations, a fixing hole position connected with the fixing device may also be arranged in the main box body 2.

In some implementations, a second sealing ring 42 is further arranged between the connecting cover 32 and the main box body 2.

A first waterproof edge 324 extending towards the outer cover 33 is arranged on at least part of a region on the connecting cover 32 of the present disclosure surrounding the opening 322, a second waterproof edge 331 extending towards the connecting cover 32 is arranged on the outer cover 33, and when the outer cover 33 is closed onto the connecting cover 32, side walls of the first waterproof edge 324 and the second waterproof edge 331 are attached to each other. Therefore, liquid (e.g., water) can be effectively prevented from entering the junction box via the opening 322 to affect the connector portion.

The waterproof junction box of the present disclosure further includes an interface sealing portion 5, the interface sealing portion 5 is arranged at a region of the lead interface 31, the lead is able to penetrate through the interface sealing portion 5, a drainage gap 53 is located between the interface sealing portion 5 and a wall portion of a region of the cover body 3 where the lead interface 31 is arranged, and a side of the lead interface 31 close to the main box body 2 has a lead draining groove 311 recessed towards the main box body 2. Therefore, by arranging the interface sealing portion 5, it can be ensured that water cannot seep into the junction box from the region of the lead interface 31 when the lead is guided out, and the lead draining groove 311 is arranged to discharge few liquids located in the drainage gap 53.

The first waterproof edge 324 and the second waterproof edge 331 are interrupted at a region of the interface sealing portion 5 to form a mounting opening 34, an accommodating groove 326 for arranging the interface sealing portion 5 is arranged at a region on the connecting cover 32 corresponding to the mounting opening 34, and a groove wall of one side of the accommodating groove 326 close to the opening 322 extends away from the main box body 2. Therefore, the interface sealing portion 5 can form a waterproof structure together with the first waterproof edge 324 and the second waterproof edge 331 so as to effectively prevent liquid from entering the main box body 2. The groove wall of the side of the accommodating groove 326 close to the opening 322 extends away from the main box body 2, so that seeping liquid can be blocked by the groove wall and cannot enter the waterproof box. A tail end of the first waterproof edge 324 close to the interface sealing portion 5 has a bent area 3241 extending away from the opening 322, the bent area 3241 extends towards the interface sealing portion 5, the groove wall of the side of the accommodating groove 326 close to the water collecting area 321 is a water blocking wall 3261, and the water blocking wall 3261 extends away from the main box body 2. The second waterproof edge 331 may adopt the consistent shape with the first waterproof edge 324 to achieve tight fit of the two. Therefore, the liquid in the water collecting area 321 can be isolated effectively, is prevented from entering the region of the accommodating groove 326, and is discharged from the drain hole 323 with a high drainage volume.

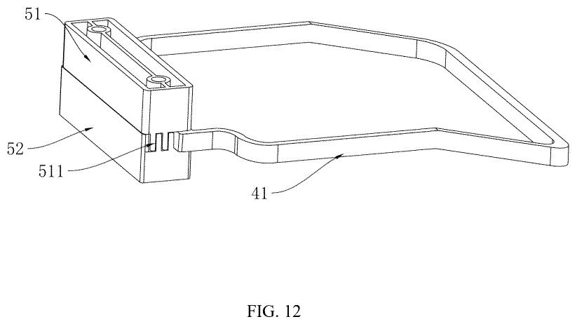

In some implementations, the interface sealing portion 5 includes an interface sealing member I 51 and an interface sealing member II 52, a plurality of waterproof blocking sheets 511 (FIG. 12) which are staggered and attached to each other are arranged on surfaces of the interface sealing member I 51 and the interface sealing member II 52 that are close to each other, and therefore, through the cooperation of the waterproof blocking sheets 511 of the interface sealing member I 51 and the interface sealing member II 52, the sealing effect of the interface sealing portion 5 is further improved, such that the lead interface 31 is effectively sealed.

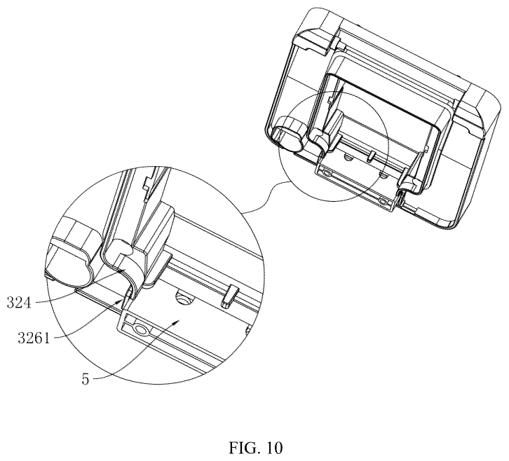

In conjunction with FIG. 7, a sealing groove 325 is further arranged around an outside of the first waterproof edge 324, a first sealing ring 41 is arranged in the sealing groove 325, and the first sealing ring 41 protrudes from a bottom wall of the water collecting area 321 and is able to abut against the water blocking wall 3261 (FIG. 10). Therefore, the water collecting area 321 and the region where the lead interface 31 is arranged are isolated to the maximum extent to reduce liquid entering the region of the lead interface 31 as much as possible.

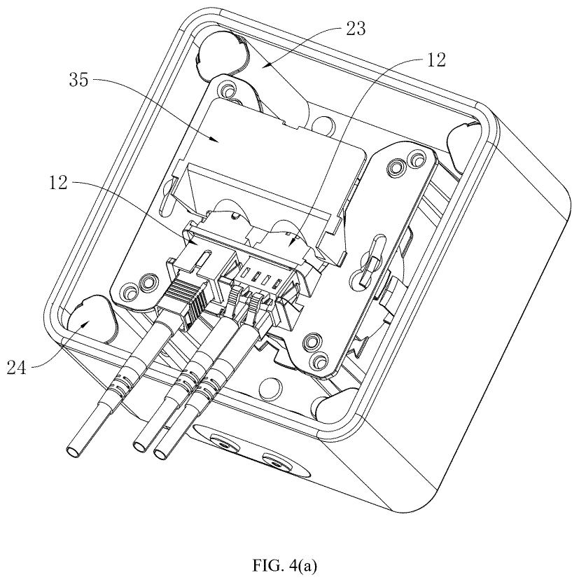

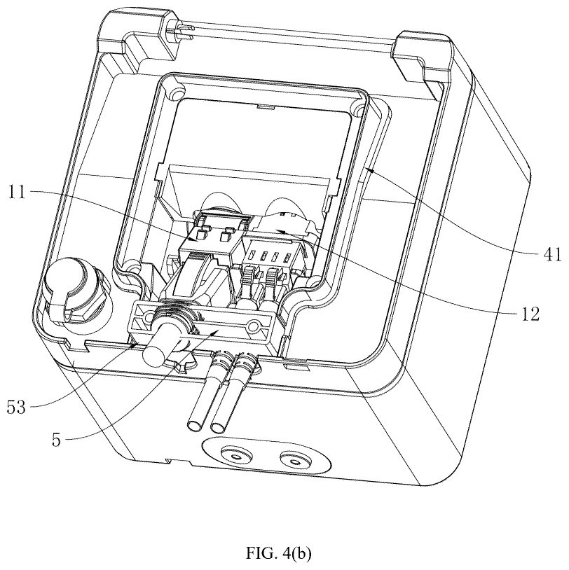

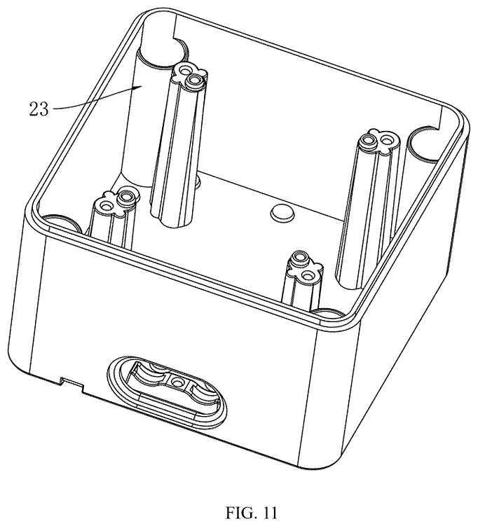

At least one mounting hole 22 is formed in the mounting surface 21 of the main box body 2, the main box body 2 is fixed by a bolt penetrating through the mounting hole 22, a waterproof sleeve 23 (FIG. 11) extending from an inner side wall of the mounting surface 21 of the main box body 2 into the main box body 2 is arranged around the mounting hole 22, and a waterproof cover 24 (in conjunction with FIG. 4(a)) for blocking the mounting hole 22 is arranged at one end of the waterproof sleeve 23 located inside the main box body 2. Therefore, after the main box body 2 is fixed by the bolt penetrating through the mounting hole 22, the waterproof cover 24 is closed onto one end of the waterproof sleeve 23, and then liquid can be prevented from entering the waterproof junction box via the mounting hole 22, thus effectively performing the waterproof effect. When the waterproof junction box needs to be rotated by an angle to different mounting positions, the waterproof cover 24 may be taken down first, and then a disassembling action of the main box body 2 is performed, which meets the use requirement that the junction box needs to be rotated by different mounting angles during practical use.

The waterproof sleeve 23 may be a barrel-shaped structure independently arranged on the inner side of the mounting surface 21, or may form a hollow-column-like structure together with the inner side wall of the main box body 2 by using a partial structure of the inner side wall of the main box body 2.

In some implementations, four mounting holes 22 are provided, and when the main box body 2 is located at the first mounting position, the second mounting position, the third mounting position and the fourth mounting position respectively, the respective mounting holes 22 have the same projection on a surface where mounting is to be performed. Therefore, a user can adjust the mounting angle of the main box body 2 as required. Since before and after rotating the main box body 2, the respective mounting holes 22 correspond to the same mounting structure (e.g., the positions of the mounting holes 22, etc.), the main box body 2 can be conveniently mounted and fixed at multiple angles. For example, the mounting holes 22 are of a runway-type structure as shown in FIG. 9, and are distributed in a circular array on the mounting surface 21 of the waterproof box, and the hole length direction of each mounting hole 22 is perpendicular to a connecting line with the center of the waterproof box, ensuring that the main box body 2 can be conveniently mounted through the four mounting holes 22 when it is located at different mounting positions.

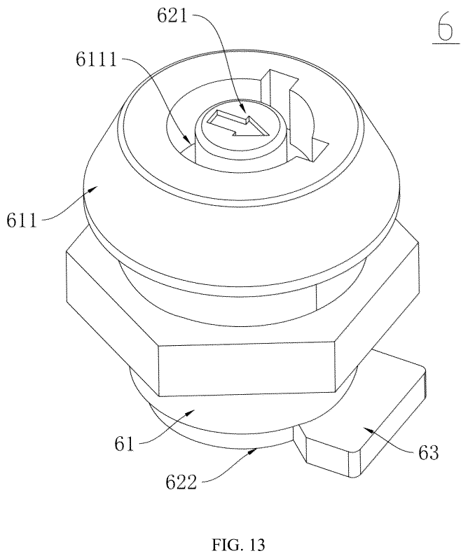

Referring to FIG. 13, the waterproof junction box of the present disclosure further includes at least one locking portion 6 used for locking the outer cover 33 and the connecting cover 32. The locking portion 6 includes a locking sleeve 61 and a lock bar arranged inside the locking sleeve 61 and able to rotate relative to the locking sleeve 61. One end of the lock bar is an unlocking end 621, and the other end is a lock head end 622. The unlocking end 621 is located at an end of the locking sleeve 61 away from the connecting cover 32. One end of the locking sleeve 61 away from the connecting cover 32 has a limiting end 611 coaxial with and communicating with the locking sleeve 61. The outer cover 33 is provided with a through hole for the locking portion 61 of the locking portion 6 to pass, and an outer diameter of one side of the limiting end 611 close to the outer cover 33 is greater than a diameter of the through hole. Therefore, the locking portion 6 and the outer cover 33 can be locked by the limiting end 611.

The lock head end 622 is further provided with a lock plate 63, the connecting cover 32 is provided with a locking hole 64, a limiting wall 641 (FIG. 7) capable of shielding part of a region of the locking hole 64 is arranged on one side of the locking hole 64 close to the limiting end 611, the lock plate 63 is arranged at one end of the locking portion 6 extending into the locking hole 64, and the lock plate 63 is able to rotate to abut against the limiting wall 641. Therefore, the locking portion 6 can be fixed to or released from the cover body 3 just by slightly rotating the locking portion 6 to enable the lock plate 63 to abut against the limiting wall 641 or not, so that locking or unlocking of the outer cover 33 and the connecting cover 32 is facilitated. A size of a region not shielded by the limiting wall 641 is a little bit larger than that of the lock plate 63, so that the lock plate 63 can penetrate into the locking hole 64 conveniently and be rotated to abut against the limiting wall 641 so as to achieve the locking effect.

A cylindrical hole 6111 capable of communicating with the locking sleeve 61 is formed in the middle of the limiting end 611, and the unlocking end 621 is located in the cylindrical hole 6111, so that a key may extend into the cylindrical hole 6111 to match with the unlocking end 621, and the lock bar is rotated to achieve unlocking or locking.

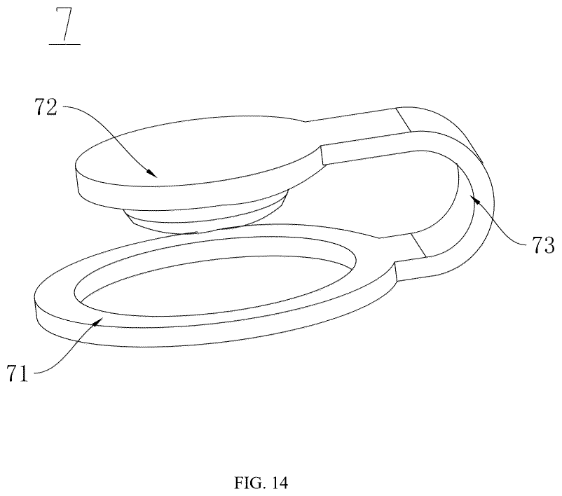

Referring to FIG. 14, the locking portion 6 of the waterproof junction box of the present disclosure further includes a waterproof member 7 used for resisting water for the through hole which is formed in the outer cover 33 for the locking portion 6 to pass, and the waterproof member 7 includes a waterproof ring 71, a waterproof cap 72 and a connecting arm 73 connected to the waterproof ring 71 and the waterproof cap 72. The waterproof ring 71 can sleeve an outer side of the locking sleeve 61, and the waterproof ring 71 can abut against an outer surface of the limiting end 611 and an outer surface of the connecting cover 32, so that water seepage occurring at the mounting hole 22 can be avoided. The waterproof cap 72 can be closed onto the outer surface of the limiting end 611 and seal the cylindrical hole 6111. Therefore, the waterproof member 7 can be mounted in place in one time as long as the locking portion 6 is sleeved with the waterproof ring 71. When no unlocking or locking action is required, seepage at the locking portion 6 can be prevented just by covering the cylindrical hole 6111 with the waterproof cap 72.

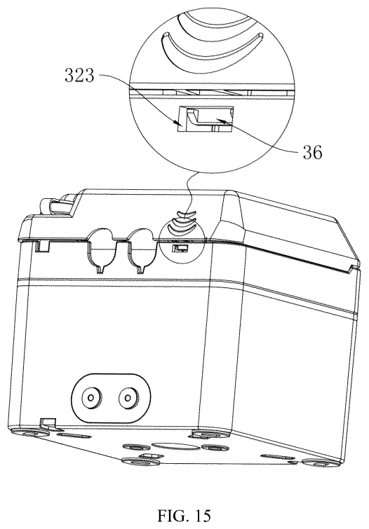

In some implementations, the waterproof junction box of the present disclosure further includes a clamping portion. Referring to FIG. 15, the clamping portion includes a clamping tongue 36 arranged on one side of the cover body 3 close to the main box body 2 and extending towards the main box body 2. When the cover body 3 and the main box body 2 are closed, the clamping tongue 36 is able to be clamped into the drain hole 323. Therefore, by ingeniously using the original arrangement structure of the drain hole 323, while a clamping effect on the cover body 3 is ensured, water leakage occurring at the clamping position is avoided, without adding an arrangement structure of the box body.

In some implementations, the locking portion 6 is arranged close to an edge of one side of the cover body 3, and the clamping portion is arranged on a region of the cover body 3 opposite to the locking portion 6. The locking portion 6 and the clamping portion are arranged on the cover body 3 in a substantially symmetrical mode, and are located at an edge away from the hinged side of the cover body 3 and the main box body 2. Therefore, the cover body 3 and the main box body 2 can bear balanced force when fixed.

The above implementations are only used for describing the technical concepts and characteristics of the present disclosure, and its purpose is to enable those skilled in the art to understand the content of the present disclosure and implement it, but it cannot limit the protection scope of the present disclosure thereby. Any equivalent changes or modifications made in accordance with the spirit of the present disclosure shall be covered by the protection scope of the present disclosure.

What is claimed is:

1. A multifunctional waterproof junction box with wires entering from four surfaces, used for accommodating a connector portion, wherein the connector portion is at least one of a data connector or an electric socket, the multifunctional waterproof junction box comprises a main box body (2) and a cover body (3) detachably connected to the main box body (2), a terminal (25) is arranged on at least one side wall of the main box body (2), and the cover body (3) is provided with a lead interface (31) used for a lead connected to the connector portion to penetrate out,
the cover body (3) comprises:
a connecting cover (32), wherein the connecting cover (32) is connected to the main box body (2), and an opening (322) for exposing a connector region of the connector portion is formed in the middle of the connecting cover (32); and
an outer cover (33), wherein the outer cover (33) is in hinged connection with the connecting cover (32) and is able to be mutually closed with the connecting cover (32),
a side of the main box body (2) away from the cover body (3) is a mounting surface (21), any position for fixing the main box body (2) through the mounting surface (21) is a first mounting position, the main box body (2) is rotated around a central axis thereof and is rotated by an angle of 90 degrees each time so as to correspond to a second mounting position, a third mounting position and a fourth mounting position of the main box body (2) sequentially, and when the main box body (2) is located at the first mounting position, the second mounting position, the third mounting position and the fourth mounting position respectively, the cover body (3) is in the same mounting state, and a region where the main box body (2) is fixed is always the same region,
the multifunctional waterproof junction box further comprises an interface sealing portion (5), the interface sealing portion (5) is arranged at a region of the lead interface (31), the lead is able to penetrate through the interface sealing portion (5), a drainage gap (53) is located between the interface sealing portion (5) and a wall portion of a region of the cover body (3) where the lead interface (31) is arranged, and a side of the lead interface (31) close to the main box body (2) has a lead draining groove (311) recessed towards the main box body (2),
a water collecting area (321) is arranged on one side of the connecting cover (32) close to the outer cover (33), when the outer cover (33) and the connecting cover (32) are mutually closed, the water collecting area (321) and the opening (322) are isolated from each other, and a drain hole (323) capable of communicating with the water collecting area (321) is formed in an edge of one side of the connecting cover (32).

2. The multifunctional waterproof junction box with wires entering from four surfaces according to claim 1, wherein a first waterproof edge (324) extending towards the outer cover (33) is arranged on at least part of a region on the connecting cover (32) surrounding the opening (322), a second waterproof edge (331) extending towards the connecting cover (32) is arranged on the outer cover (33), and when the outer cover (33) is closed onto the connecting cover (32), side walls of the first waterproof edge (324) and the second waterproof edge (331) are attached to each other.

3. The multifunctional waterproof junction box with wires entering from four surfaces according to claim 2, wherein the first waterproof edge (324) and the second waterproof edge (331) are interrupted at a region of the interface sealing portion (5) to form a mounting opening (34), an accommodating groove (326) for arranging the interface sealing portion (5) is arranged at a region on the connecting cover (32) corresponding to the mounting opening (34), a groove wall of one side of the accommodating groove (326) close to the opening (322) extends away from the main box body (2), a tail end of the first waterproof edge (324) close to the interface sealing portion (5) has a bent area (3241) extending away from the opening (322), the bent area (3241) extends towards the interface sealing portion (5), and the accommodating groove (326) has a water blocking wall (3261) extending away from the main box body (2).

4. The multifunctional waterproof junction box with wires entering from four surfaces according to claim 3, wherein a sealing groove (325) is further arranged around an outside of the first waterproof edge (324), a first sealing ring (41) is arranged in the sealing groove (325), and the first sealing ring (41) is able to abut against the water blocking wall (3261).

5. The multifunctional waterproof junction box with wires entering from four surfaces according to claim 1, wherein at least one mounting hole (22) is formed in the mounting surface (21) of the main box body (2), a waterproof sleeve (23) extending from an inner side wall of the mounting surface (21) of the main box body (2) into the main box body (2) is arranged around the mounting hole (22), and a waterproof cover (24) for blocking the mounting hole (22) is arranged at one end of the waterproof sleeve (23) located inside the main box body (2).

6. The multifunctional waterproof junction box with wires entering from four surfaces according to claim 5, wherein four mounting holes (22) are provided, and when the main box body (2) is located at the first mounting position, the second mounting position, the third mounting position and the fourth mounting position respectively, the respective mounting holes (22) have the same projection on a surface where mounting is to be performed.

7. The multifunctional waterproof junction box with wires entering from four surfaces according to claim 1, further comprising at least one locking portion (6) used for locking the outer cover (33) and the connecting cover (32), wherein the outer cover (33) is provided with a through hole for the locking portion (6) to pass, the locking portion (6) has a limiting end (611), an outer diameter of one side of the limiting end (611) close to the outer cover (33) is greater than a diameter of the through hole, the locking portion (6) further comprises a waterproof member (7), the waterproof member (7) comprises a waterproof ring (71), the waterproof ring (71) sleeves the locking portion (6), and the waterproof ring (71) is able to abut against the limiting end (611) and an outer surface of the connecting cover (32) respectively.

8. The multifunctional waterproof junction box with wires entering from four surfaces according to claim 7, wherein the locking portion (6) comprises a locking sleeve (61) and a lock bar arranged inside the locking sleeve (61) and able to rotate relative to the locking sleeve (61), one end of the lock bar is an unlocking end (621), the other end is a lock head end (622), the unlocking end (621) is located at an end of the locking sleeve (61) away from the connecting cover (32), a cylindrical hole (6111) capable of communicating with the locking sleeve (61) is provided in the middle of the limiting end (611), the unlocking end (621) is located in the cylindrical hole (6111), the waterproof member (7) further comprises a waterproof cap (72) capable of sealing the cylindrical hole (6111) and a connecting arm (73) connected to the waterproof ring (71) and the waterproof cap (72) respectively, the lock head end (622) is further provided with a lock plate (63), the connecting cover (32) is provided with a locking hole (64), a limiting wall (641) capable of shielding part of a region of the locking hole (64) is arranged on one side of the locking hole (64) close to the limiting end (611), the lock plate (63) is arranged at one end of the locking portion (6) extending into the locking hole (64), and the lock plate (63) is able to rotate to abut against the limiting wall (641).

9. The multifunctional waterproof junction box with wires entering from four surfaces according to claim 1, further comprising a clamping portion for clamping the cover body (3) and the main box body (2), wherein the clamping portion comprises a clamping tongue (36) arranged on the cover body (3), and when the cover body (3) and the main box body (2) are closed, the clamping tongue (36) is able to be clamped into the drain hole (323).
